(19) United States
(12) Patent Application Publication
(10) Pub. No.: US 2016/0077686 A1
(43) Pub. Date: Mar. 17, 2016

(54) Easy-to-use grid-based user interface and navigation model for smart tv devices

(71) Applicant: NPG Technology, S.A., Torrejon de Ardoz (ES)

(72) Inventors: Enrique Cosío, Madrid (ES); Miguel Angel Perez, Madrid (ES)

(21) Appl. No.: 14/682,128

(22) Filed: Apr. 9, 2015

Related U.S. Application Data
(60) Provisional application No. 62/001,074, filed on May 21, 2014.

(51) Int. Cl. G06F 3/0482; G06F 3/0481; G06F 3/0485

(52) U.S. Cl. CPC G06F 3/0482; G06F 3/0485; G06F 3/04817

(57) ABSTRACT

The embodiment this patent proposes is a User Interface (Portal) for Smart TV devices composed of a grid of different types of elements: Sections, Applications, Widgets and Anchor Spaces. This grid of elements can be scrolled to the left or to the right to allow the user to access hidden elements. All the elements of the Portal may perform a default operation depending on the type of element and its status when they are focused. In addition, a Long Click/Press Behaviour is also unveiled. By pressing the Ok button of the remote controller for a couple of seconds over a focused application element of the Portal, the system will open up a contextual menu with different options that will allow the user to perform several tasks over the selected element, like de-anchoring, moving and uninstalling applications. This behaviour is replicated by means of the Tools button of the remote controller. A similar Long Click/Press Behaviour over the All Apps Screen is also considered.

### REFERENCES CITED

### U.S. Patent Documents

### D626,135 October 2010 Choi, et al.

### D625,321 October 2010 Choi, et al.

### D698,359 S January 2014 Ray

U.S. Pat. No. 6,335,736 January 2002 Wagner, et al.
U.S. Pat. No. 6,614,455 September 2003 Cuijpers, et al.
U.S. Pat. No. 6,600,496 July 2003 Wagner, et al.
U.S. Pat. No. 6,871,323 March 2005 Wagner, et al.
U.S. Pat. No. 6,976,228 December 2005 Bernhardson
U.S. Pat. No. 7,076,734 July 2006 Wolff, et al.
U.S. Pat. No. 7,475,349 January 2009 Wagner, et al.
U.S. Pat. No. 7,876,382 January 2011 Imaizumi
U.S. Pat. No. 8,196,174 June 2012 Piepenbrink, et al.
U.S. Pat. No. 8,763,045 June 2014 White et al.
U.S. Pat. No. 8,943,440 B2 January 2015 Adderton
U.S. Pat. No. 8,984,436 March 2015 Tseng, et al.

### BACKGROUND OF THE INVENTION TECHNICAL FIELD

The present invention relates generally to display systems, and in particular relates to a smart TV display system. More specifically the invention relates to methods and systems enabling users to interact using remote controllers with images created and displayed by electronic devices.

### DESCRIPTION OF THE TECHNICAL FIELD

Smart TV has emerged as a new way of accessing Internet content and applications by using a big-screen device traditionally used for other purposes, such as watching TV programs or playing recorded video content. The Smart TV is generally conceived as a device that integrates access to the Internet and Web 2.0 features into television sets, thus representing the trend of technological convergence between computers and television sets and allowing the user for enhanced experience in entertainment, business applications, social interaction and content creation and/or consumption.

The overall design and functionality of the device provides for an improved user experience making the device more useful and more efficient. With the advent of Smart TV conventional TV experience is highly enhanced by the integration of other sources available on the Internet, whether Video-On-Demand (VoD) or IPTV streaming services, gaming, interactive advertising, social networking, and an enormous amount of innovative multimedia applications.

TV devices are supported on powerful hardware platforms, including high-performance multi-core CPUs and GPUs, advanced connectivity modules and offering more and more big-size screens. Running on top of this hardware many TVs are equipped with an integrated Operating System (OS) that allows applications to invoke native services and that offers a Graphical User Interface (GUI) commonly targeted to a PC, laptop, tablet or mobile phone.

The screen size of Smart TV devices allows the customer to interact in different ways in order to achieve a maximized user experience. Unfortunately, most Smart TVs have yet to provide seamless and intuitive user interfaces for navigating and/or executing the various features of the Smart TV. The solution we are proposing in this invention comprises a navigation model that allows the customer to get a seamless experience, so that she can conceive the big screen like a global home entertainment centre.

### BRIEF SUMMARY OF THE INVENTION

A Smart TV is generally conceived as a device that integrates access to the Internet and Web 2.0 features into television sets, thus representing the trend of technological convergence between computers and television sets and allowing the user for an enhanced experience in entertainment, business applications, social interaction and content creation and/or consumption.

The best part about owing a Smart TV is that the user can play back content from different sources like photos, movies, and the like, whether locally or remotely stored, without moving a single muscle. The user will be able to surf the Web using an Internet search engine, connect/interact with social media sites and/or an online community and execute different types of applications (games, productivity, etc.). Modern Smart TVs also include technologies like DLNA and Miracast, and newest phones can take advantage of these, so that the user can share home videos or similar contents wirelessly on the large screen. In fact, the remote controller however is not a device invented primarily to browse the Web, search movies by title or actors, switching off adverts that sometimes become annoying or typing words in search engines. However the TV is still the device which is the centrepiece of a living room, where people go to have fun and relax. So, the challenge is how to adapt this centrepiece to the ease-of-use needs of the end-user. Therefore simplicity and navigation ergonomics are the most important requirements after features when designing modern interface architecture.

This application introduces an embodiment to simplify the interactions a user can perform with the conventional functionality of a Smart TV device. In order to accomplish this task, the user interface has been designed as a grid-based organization of applications with a navigation model that allows the user to easily access the different elements available and open up contextual menus to select functional operations over those elements.

Grid organization, scrolling, favourite selection and a long click behaviour over different elements all contribute to an enhanced user experience when accessing the functionality of Smart TV devices

### BRIEF DESCRIPTION OF THE DRAWINGS

FIG. 1 shows the Start Screen or Portal which has been divided into different sections or categories allowing the user to access a pre-filled portfolio of related applications. Initially this Start Screen is pre-defined with the following sections:
Section #1
   Main Category, including Broadcast TV or IPTV Preview (depending on whether the device includes a TV tuner or not), Web Browser, Media Player, Application Store, All Applications and Advertising Banner.
Section #2
   Video On Demand (VoD) Category, providing the user access to all pre-installed apps under this category
Section #3
   Current Affairs Category, providing the user access to all pre-installed apps under this category
Section #4
   Leisure Category, providing the user access to all pre-installed apps under this category
Section #5
   Uncategorized, providing the user access to all pre-installed apps with no specific category

FIG. 2 shows the Scrolling System that allows the movement of the content of the Start Screen in order to view the elements which are not visible (out of the screen area).

FIG. 3 shows the Long Click/Press Behaviour over the Start Screen. By pressing the Ok button of the remote controller for a couple of seconds over an element of the Start Screen, the system will open up a contextual menu with different options that will allow the user to perform several tasks over the selected element, like de-anchoring, moving and uninstalling applications. If the Long Click is applied over a widget, the user can change its configuration.

FIG. 4 shows the Long Click/Press Behaviour over the All Apps Screen. By pressing the Ok button of the remote controller for a couple of seconds over an element of the All Apps Screen, the system will open up a contextual menu with different options that will allow the user to perform several tasks over the element selected, like changing or assigning its category, uninstalling the corresponding application or getting information of the element.

### DETAILED DESCRIPTION OF THE INVENTION

### Description of the Preferred Embodiment

Detailed embodiments of the device are presented in this section.

The device can be a telecommunications device, such as a television, an electronic visual display device, or other smart device. The device can include one or more screens that are configured to receive and present information from a variety of sources. Several display controllers may be provided for controlling the operation of the screen. In accordance with other embodiments, the functions of a display controller may be incorporated into other components, such as a processor.

The processor may comprise a general purpose programmable processor or a controller for executing application programming or instructions. This processor may include multiple processor cores, implement multiple virtual processors and/or include multiple physical processors. As a particular example, the processor may comprise a specially configured application specific integrated circuit (ASIC) or other integrated circuit, a digital signal processor, a controller, a hardwired electronic or logic circuit, a programmable logic device or gate array, a special purpose computer, or the like.

The Smart TV can include a module for encoding/decoding and/or compression/decompression for receiving and managing digital television information. Encoding/decoding compression/decompression module enables decompression and/or decoding of analogic and/or digital information dispatched by a public television chain or in a private television network and received across antenna, I/O module, wireless connectivity module, and/or other wireless communications modules. Any encoding/decoding and compression/decompression can be performed on the basis of various formats (e.g., audio, video, and data).

Regarding communications, some embodiments of Smart TV may be equipped with multiple communication means in order to communicate across Local Area Networks (LANs), wireless local area networks (WLANs), and other networks. Among other things, the Smart TV may use these network connections to send and receive information, interact with an electronic program guide (EPG), receive software updates, contact customer service, and/or access remotely stored digital media libraries (e.g. through protocols like DLNA or SAMBA). In addition, these connections will allow the Smart TV to send and/or receive email messages, surf the Web using an Internet search engine, and connect/interact with social media sites and/or an online community (e.g., Facebook™, Twitter™, Linkedln™, Google+™, and the like). In combination with other components, like cameras or microphones, these network connections also enable the Smart TV to establish video teleconferences, electronic meetings, and other communications.

The Smart TV can also be configured to receive and understand a variety of user and/or device inputs. For example, a user may interface with the Smart TV via one or more physical or electrical controls, such as buttons, switches, touch sensitive screens/regions (e.g., capacitive touch, resistive touch, etc.), and/or other controls associated with the Smart TV. Alternatively, these controls may be associated with a remote controller.

The remote controller can communicate with the Smart TV via wired and/or wireless signals: radio frequency (RF), infrared (IR), and/or a specific wireless communications protocol (e.g., Bluetooth™, Wi-Fi, etc.).

TV remote controllers are provided with a keyboard with buttons to operate several functions of the device, a D-pad (directional pad) in order to ease TV navigation, and modern remote controllers may also use motion-sensor-enabled and voice control capabilities.

On top of this hardware platform there's a software architecture that may comprise one or more layers including, but not limited to, an operating system kernel, one or more libraries, an application framework, and one or more applications. The one or more layers can communicate with each other to perform functions for the Smart TV.

An operating system (OS) kernel contains a collection of software that manages the computer hardware resources and provides services for other computer programs or software code within the Smart TV. The operating system kernel is the main component of the operating system and acts as an intermediary between the applications and data processing done within the hardware components. Part of the operating system kernel can include one or more device drivers that help operate or control a device or hardware attached to the Smart TV.

On top of the OS kernel there may be some libraries including an operating system runtime library (e.g. Java Virtual Machine and core libraries), a TV services Hardware Abstraction Layer (HAL) library, and/or a data service library (e.g. media framework, graphic libraries, database access libraries, etc.).

The upper layer may be an application framework which includes a general abstraction for providing functionality that can be selected by one or more applications to offer specific application functions or software for those applications. Thus the framework can include one or more different services, or other applications, that can be accessed by the applications to provide general functions across two or more applications. Such functions, among others include, for example, user interface components, creation of activities and views, management of one or more windows or panels, location services, notifications, telephony and data access. The application framework can include one or more TV and multimedia services and resources.

The application layer can contain applications associated with the Smart TV, so that a user can locate and execute them. Application layer may include one or more of, but is not limited to, a live TV application, a video on demand application, a multimedia centre application, an app store application, and a user interface application (launcher).

The Live TV application can provide Live TV over different signal sources. For example, the Live TV application can provide TV input from cable television, over-the-air broadcasts, from satellite services, or other types of Live TV services. Different standard digital television standards can be supported: DVB-T, DVB-T2, ATSC, DTMB, ISDB-T, etc. The TV application is supported on different framework and native library services at the lower layers of the architecture. The Live TV application can include other TV-related (pre-installed) applications, such as content searching, device viewing, setup algorithms, and coordinates to provide information to the viewer.

The video on demand application allows the playback of stored video content from different streaming sources. The sources of the video on demand can be associated with users (acting as prosumers) or with some other type of service. For example, the video on demand may be provided from an iTunes or Google Play library stored in the cloud. For video on demand the Smart TV relies on a media player service which is also located at the framework and native library levels.

IPTV technology is often used to bring video on demand and television services using the Internet protocol suite over a packet-switched network such as a LAN or the Internet, instead of being delivered through traditional terrestrial, satellite or cable television networks. Unlike downloaded media, IPTV offers the ability to stream the media in smaller batches, directly from the source. As a result, a client media player can begin playing the content (such as a movie) before the whole file has been transmitted, a technology called streaming. IPTV services can be classified into three main groups: Live TV services, with or without interactivity related to the current TV show; Time-shifted TV: catch-up TV (replaying a TV show that was broadcast some time ago), start-over TV (replaying the current TV show from its beginning); and Video on demand (VOD): browsing a catalogue of videos, related or not related to TV programming.

The multimedia centre application can provide applications for different types of media presentation from a local or remote disc storage that contains stored video programs, or from some other source, such as DLNA and SAMBA sources. DLNA uses Universal Plug and Play (UPnP) protocol for media management, discovery and control. UPnP defines the type of device that DLNA supports (“server”, “renderer”, “controller”) and the mechanisms for accessing media over a network. SAMBA is an implementation of the SMB/CIFS networking protocol used to share files and content. NFS (Network File System) is a Linux-based alternative approach. For the multimedia centre application the Smart TV relies on the media player service to play video.

The app store application allows for the provision, storage, and use of applications. An application can be a game, a productivity application, or some other application generally associated with computer systems or other devices, but may be operated within the Smart TV. An app store application may obtain these applications from different sources (e.g. Google Play, App Store, etc.), store them locally, and then execute those types of applications for the user on the Smart TV.

The applications layer can include several user interface applications as necessary to control the user interface of the Smart TV. The user interface applications can be composed of different types of panels or views.

In order to manage transitions between those views or to affect user interface inputs received in the view, a view manager is required to display view in the user interface. The view manager may thus be in communication with different user interface views such as a global view (portal or home screen), a settings panel, a TV settings menu panel, a tools panel and/or a notification panel.

The view manager can display these types of views depending on the inputs received from the input event dispatcher. The global view may include information that is associated with the home screen or top level hierarchal information for the user. A settings panel can include information displayed about the settings of the Smart TV such as connectivity, applications, device info, update management, or OS configuration. A TV settings menu panel can provide options to control picture and sound general modes of operation, channel tuning and program edit features, general settings (language, time, power, restore, etc.) and parental control options. A tools panel can be used to provide quick access or hotkeys to a different number of frequent functions, including options of the current content (picture, sound, audio, subtitles, picture-in-picture configuration, recording and content detailed information), input source (DTV, HDMI, CVBS, and so on), menu settings, EPG (Electronic Programming Guide), and PVR (Personal Video Recorder—scheduled and record lists). A notification panel can provide information about notifications to a user. These notifications can be associated with information, such as video on demand displays, favourite lists, currently provided programs, or other information. Notifications can be associated with the media or with some type of setting, or operation or the Smart TV.

For Android™ Smart TVs the Portal is a type ‘Launcher’ application that replaces the native Android™ launcher desktop and allows for a better use of the Android™ Operating System via TV remote controls (DPAD controllers via infra-red) or accelerometer-based motion controllers (motion controllers). This Portal provides the user with a graphical user interface (GUI) adapted to TVs and designed to provide an enormous variety of advanced services targeted to Smart TVs.

The difference between a TV experience that feels right and one that does not greatly depends on the number, spacing, and size of on-screen elements. Although TV sizes and resolutions have steadily increased over time, users expect TV experiences to be relatively simple and uncluttered.

The embodiment this patent proposes is a Portal composed of a grid of different types of elements, as referred to in FIG. 1. We can distinguish the following types of elements: Sections, Applications, Widgets and Anchor Spaces.

Sections (or Categories) are groups of related elements according to a particular classification. All the members of a particular category share some features in common and have an associated name that describes how to identify the category to which they belong. Initially the Portal is pre-filled with the following sections:
Section #1
   Main Category
Section #2
   Video On Demand (VoD) Category
Section #3
   Current Affairs Category
Section #4
   Leisure Category
Section #5
   Uncategorized

The user can navigate among categories by pressing the D-pad keys of the remote controller or conversely move the pointer of the motion controller to the desired location. Gesture or voice controlled navigation input methods can also be supported, provided that the embodiment of the Smart TV includes the appropriate mechanisms (e.g. microphone for voice detection).

In order to ease the navigation among categories with the D-pad keys of the remote controller, a quick-access pull-right tab is provided on the left hand side of the Portal that allows the user to select a particular category with a reduced amount of clicks. The user can select this tab by pressing the left key of the D-pad controller or alternatively by displacing the pointer of the motion controller to the left area of the screen. A selection panel appears which allows the user to click on a specific category by pressing ore or more times the down key of the D-pad controller, or by moving the pointer to the selected category and then clicking the ok button of the remote controller.

Applications are elements that link to available applications already installed. When the user clicks on an application element, the corresponding application (whether a productivity application, a game, or whatever.) is launched and starts running on the system. This application becomes the active process on an Android™ Smart TV, so the application element behaves as a link to the real application.

Applications are represented as square icons on the grid (filled in light blue colour on FIG. 1). There may be highlighted applications which are represented as double-size icons that occupy a double horizontal room on the screen, allowing the user an easy access to them.

A widget element represents a small application with limited functionality that can be installed and executed on the Portal. These widgets typically play the role of auxiliary applications which provide the user with useful information fetched from external sites or services and displayed in place. Examples of widgets can be on-screen devices such as clocks, event countdowns, stock market tickers, flight arrival information, daily weather, and so on.

Widgets are also represented as square icons on the grid (filled in dark blue colour on FIG. 1). Widgets on the Portal are used to accomplish different tasks. The most important widget is located on the top left corner of the main category section and provides a Broadcast TV or IPTV preview (depending on whether the device includes a TV tuner or not). This is an outstanding widget and occupies a big portion of the main category section.

Other important widgets are the All Apps and Banner Home widgets. They are also located at the bottom of the main category section and are used to provide the user with a quick access to the listing of all installed applications on the Smart TV embodiment and advertising-related information.

Two additional highlighted widgets are the RSS widget, that provides access to the portfolio of RSS feeds the user is subscribed to, the Picture Gallery widget, that provides access to the picture gallery, and the Android™ Native Launcher, which are represented as double-size icons that occupy a double horizontal room on the screen, allowing the user an easy access to them.

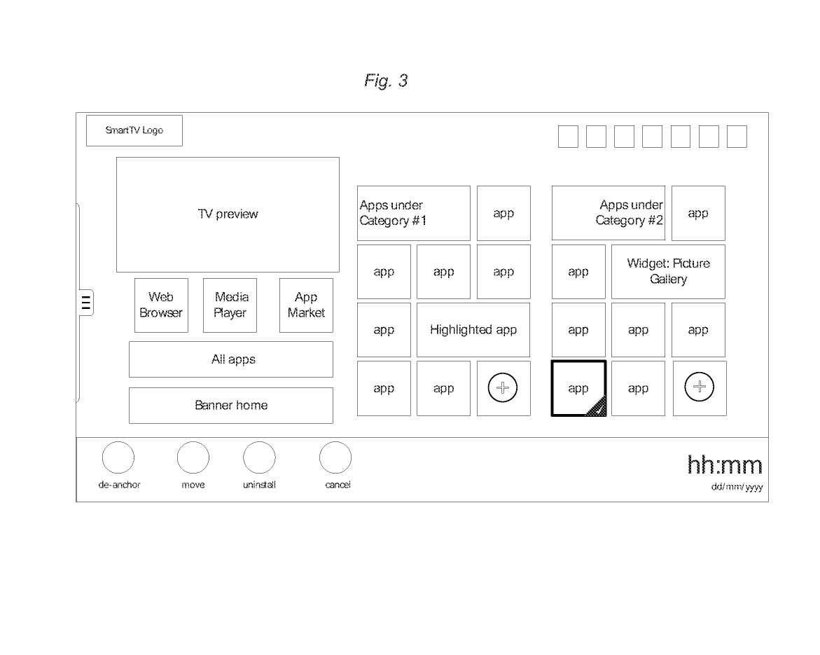

The Anchor Spaces represent a room to add favourite applications of the user, one per each category section. Anchor Spaces are represented as square void icons on the grid (filled in light blue colour on FIG. 1) with a plus (“+”) sign inside. These icons represent a free space to anchor a user-selected application from the listing of all applications already installed. The behaviour of the anchoring and de-anchoring process is related to FIG. 3 and well described ahead on this request.

A section element (or category) contains therefore a combination of applications, widgets and anchor spaces.

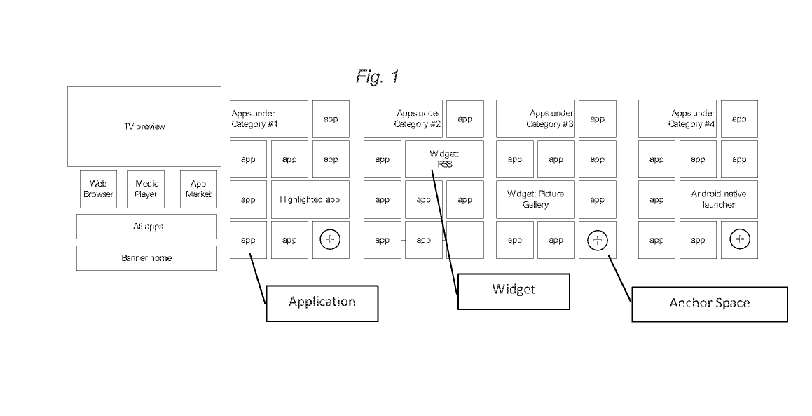

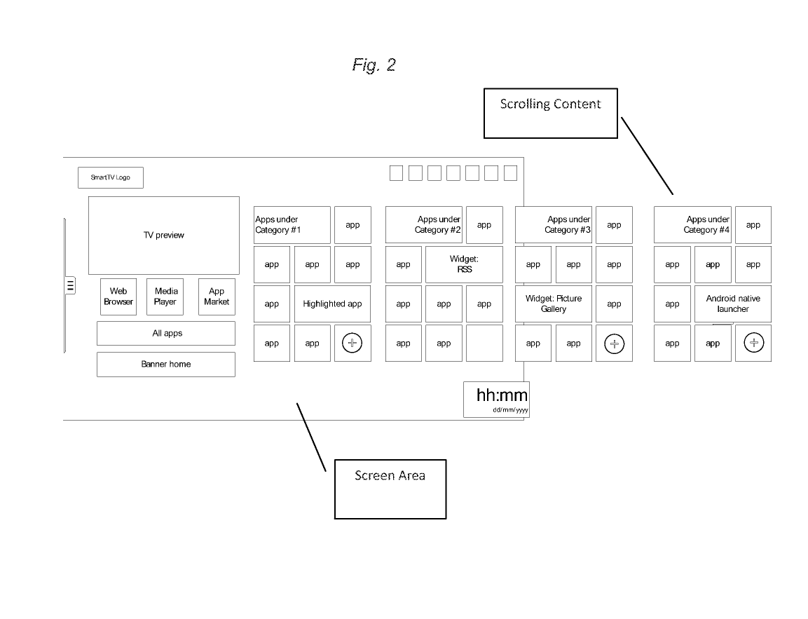

The grid of elements that appear on the Portal can be scrolled to the left or to the right to allow the user to access hidden elements. FIG. 2 represents a schema of the proposed embodiment for the scrolling behaviour.

On top of the screen there are some fixed elements that do not move when performing a scrolling operation, acting like a topbar. These elements include: a Smart TV logo at the top left corner of the screen, several quick access icons at the top right corner of the screen and a widget containing date and time information at the bottom right corner of the screen.

Quick access icons at the top right corner of the screen provide the following functionality:
access to the multimedia file explorer (local or networked storage)
wireless network configuration
e-mail
searching capabilities
device notifications
user configuration, that includes both settings and help information: manual, FAQ, contact, configuration assistant and tutorial (these two latter are executed during first boot of the device)

The scrolling behaviour is performed as indicated on FIG. 2.

Scrolling to the right allows the user to display the hidden content not visible on the screen area. This scroll is performed when the user sets the focus on the next element to the right of the last element visible on the right hand side of the Portal. This operation implies a displacement of the hidden elements on the right hand side of the screen onto the visible area. The previously visible elements on the left hand side of the screen now get hidden behind the main section/category. The main section is unaltered.

Scrolling to the left allows the user to display the hidden content not visible on the screen. This scroll is performed when the user set the focus on the next element to the left of the last element visible on the left hand side of the Portal. This operation implies a displacement of the hidden elements on the left hand side of the screen onto the visible area. The previously visible elements on the right hand side of the screen now get hidden. The main section keeps unaltered again.

FIG. 3 shows the Long Click/Press behaviour over the elements of the Portal. In order to improve the user experience, an alternative key option is provided. The same behaviour is also achieved by clicking the Tools button from the remote controller

All the elements of the Portal may perform a default operation depending on the type of element and its status when they are focused. Setting the focus on a specified element can be done by pressing the D-pad keys (left, down, right, up) with an IR remote controller or by hovering the pointer over the element with a motion remote controller. This operation selects a particular element of the Portal.

Sections elements (categories) default behaviour is giving the user access to the whole list of installed applications belonging to the category under selection. A menu containing all the applications installed for this category will appear and the user can execute a specific application by clicking on it (pressing the ok button of the remote controller).

Applications of the Portal display a descriptive name when they are focused. This name is represented as a tooltip (marked in blue colour) at the bottom of the icon only if the application is installed; if the application is not installed, the default operation is Install (marked in red colour), and this operation is displayed when the application gets the focus (it's selected). By clicking this option with the remote controller, the application is downloaded from the application store and then installed on the system. When the application is already installed, the icon shows its descriptive name as a tooltip (marked in blue colour) at the bottom of the icon when the focus is over.

Widgets don't include a default operation. Widgets of the main section are special widgets, and are used to provide highlighted information to the user, like previewing the DTV or IPTV, offering a quick access to the All Apps screen and displaying advertising banners. The left side of FIG. 1 shows the widget distribution for this section.

The default operation for Anchor Spaces is Add. When you click this option, you can select one of the applications from the available list of previously installed applications and make it accessible to the user on this anchor space. The anchor space icon (+) is replaced by the icon of the application together with a descriptive name which is displayed when the application is focused. Now the anchor space behaves like an application element, linking to the real application installed on the system. If you click this application element, the application is launched and starts running on the screen.

By pressing the Ok button of the remote controller for a couple of seconds over an application element of the Portal, the system will open up a contextual menu with different options that will allow the user to perform several tasks over the selected element, like de-anchoring, moving and uninstalling applications. This behaviour is represented on FIG. 3 and is replicated by means of the Tools button of the remote controller, so that the user can have an alternative option and achieve an improved user experience if she is not used to the long click operation. If you click on the De-anchor option of the contextual menu, the focused application element (link) will be removed and replaced by an anchor space (+). If you press on the Uninstall option of the contextual menu, the selected application will be uninstalled from the system. This operation is confirmed by means of a popup dialog allowing the user to accept or cancel the operation. If you click on the Move option from the contextual menu, you can select an available anchor space from the same category which the application belongs to, and move that application to the corresponding location.

If the Long Click is applied over a widget, the user can change its configuration. The same operation applies if the user presses the Tools button from the remote controller. The tasks a user can perform to configure the behaviour of a widget depend on the type of widget, but mainly refers to changing the data source, the frequency of display and the restoration of default values. For instance, the Image Gallery widget allows the user to set the following parameters on the contextual menu that appears with the Long Click operation: Folder (this option allows the user to select the input source to display images from different sources available), Frequency (the user can adjust the interval time elapsed between images to be displayed) and Restore (to get the default configuration values for Folder and Frequency parameters).

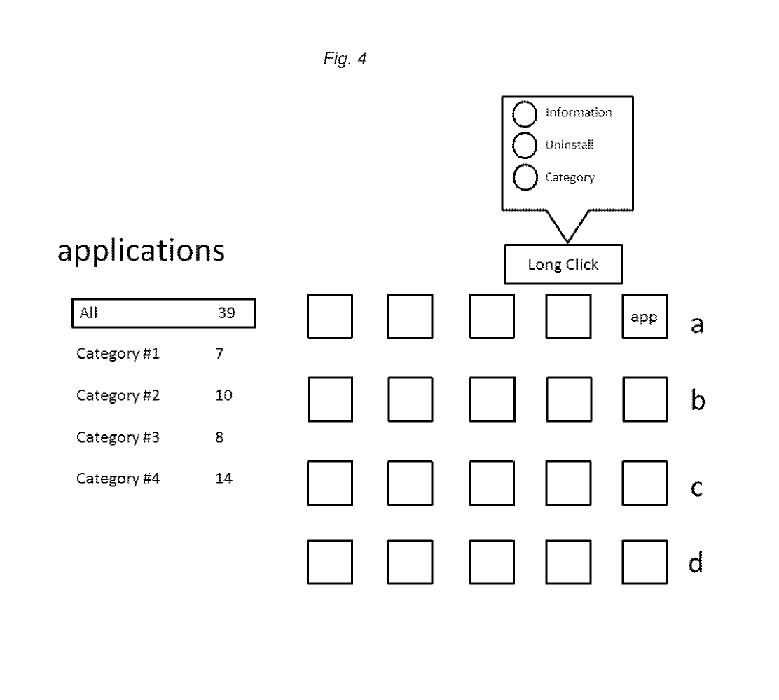

FIG. 4 shows the Long Click/Press behaviour over the installed applications. In order to improve the user experience, an alternative key option is provided. The same behaviour is also achieved by clicking the Tools button from the remote controller.

Setting the focus on a specified element of the all applications view can be done by pressing the D-pad keys (left, down, right, up) with an IR remote controller or by hovering the pointer over the element with a motion remote controller. This operation selects a particular element of the panel.

By pressing the Ok button of the remote controller for a couple of seconds over an application of the installed applications panel, the system will open up a contextual menu with different options that will allow the user to perform several tasks over the selected element. This behaviour is represented on FIG. 4 and is replicated by means of the Tools button of the remote controller, so that the user can have an alternative option and achieve an improved user experience if not used to the long click operation.

The available contextual menu options are:
1. Category: this option allows the user to move the application to a different section or alternatively cancel the operation.
2. Uninstall: this option allows the user to uninstall the selected application from the system; it is a confirmed operation that must be accepted by the user in order to avoid mistakes, so the user may accept or cancel the operation before it is executed.
3. Information: this option redirects the user to a panel containing information of the application; on Android™ Operating System the Application Info panel is launched.

While this invention has been described in conjunction with preferred embodiments thereof, it is evident that alternatives, modifications and variations will be apparent to those skilled in the art. Accordingly, Applicant intends to embrace all such alternatives, modifications and variations that follow in the spirit and scope of this invention.

1. A method of providing a graphic user interface (GUI) for Android™ Smart TVs (FIG. 1), the method comprising:
A Portal composed of a grid of elements (icons) displayed on the screen, as indicated in FIG. 1.
This grid can be navigated by pressing the D-pad keys of the remote controller or conversely the pointer of the motion controller. Gesture or voice controlled navigation input methods are also supported.
A quick-access pull-right tab that appears on the left hand side of the portal to allow the user to select a particular category with a reduced amount of clicks. The user can select this tab by pressing the left key of the D-pad controller or alternatively by displacing the pointer of the motion controller to the left area of the screen. A selection panel will appear and allow the user to click on a specific category by pressing ore or more times the down key of the D-pad controller, or by moving the pointer to the selected category and then clicking the ok button of the remote controller.

2-30. (canceled)

31. The method of claim 1, wherein the Sections element provides a grouping of related elements according to a particular classification which shares some features in common and includes a descriptive name.

32. The method of claim 31, wherein the Sections element provides a default behaviour which consists of giving the user access to the whole list of installed applications belonging to the category under selection. A menu containing all the applications installed under this category will appear and the user can execute a specific application by clicking on it (pressing the ok button of the remote controller).

33. The method of claim 1, wherein the Applications elements are represented as square icons on the grid and provide a link to the available applications already installed. When the user clicks on an application element, the corresponding application (whether productivity application, a game, or whatever.) will be executed on the system. There may be highlighted applications that are represented as double-size icons that occupy a double horizontal room on the screen, allowing the user an easy access to them.

34. The method of claim 33, together with a descriptive name which is displayed when the applications elements are focused. This name is represented as a too hip (marked in blue colour) at the bottom of the icon only if the application is installed; if the application is not installed, the default operation is Install (marked in red colour), and this operation is displayed when the application gets the focus (it's selected). By clicking this option with the remote controller, the application is downloaded from the application store and then installed on the system.

35. The method of claim 1, wherein the Widget elements are represented as square icons on the grid and provide a link to small application with limited functionality that can be installed and executed on the Portal.

36. The method of claim 35, wherein the most important widget is located on the top left corner of the main category section and provides a Broadcast TV or IPTV preview (depending on whether the device includes a TV tuner or not). This is an outstanding widget that occupies a big portion of the main category section.

37. The method of claim 1, wherein the Anchor Spaces are represented as square void icons on the grid and identify a room to add favourite applications of the user, one per each category section. These icons represent a free space to anchor a user-selected application from the listing of all applications already installed.

38. The method of claim 37, wherein the Anchor Spaces include a default operation: Add. When the user clicks this option, she can select one of the applications from the available list of previously downloaded applications and make it accessible to the user on this anchor space. The anchor space icon is then replaced by the icon of the application together with a descriptive name which is displayed when the application is focused. From then on the anchor space acts as an application element, linking to the real application installed on the system. If the user clicks on this application element, the application is launched and starts running on the screen

39. A scrolling method (FIG. 2) that allows the user to display the hidden content not visible on the screen area. This scroll is performed when the user sets the focus on the next element to the right of the last element visible on the right hand side of the Portal, or alternatively when the user sets the focus on the next element to the left of the last element visible on the left hand side of the Portal. This operation causes a displacement of the hidden elements onto the visible area. The previously visible elements on the left hand side of the screen or on the right hand side of the screen, respectively, now get hidden behind the main section/category. The main section is unaltered.

40. A method of providing a contextual menu with different options by pressing the Ok button for a couple of seconds (or alternatively the Tools button) of the remote controller over an element of the Portal (FIG. 3).

41. The method of claim 40, wherein the options available for the contextual menu include different tasks over the selected application element, like de-anchoring, moving and uninstalling applications.

42. The method of claim 41, wherein the De-anchor option of the contextual menu removes the focused application element (link), which is replaced by an anchor space (+).

43. The method of claim 41, wherein the Move option of the contextual menu allows the user to select an available anchor space from the same category which the application belongs to, and move the focused application to the corresponding location.

44. The method of claim 41, wherein the Uninstall option of the contextual menu uninstalls the focused application element (link). This operation is confirmed by means of a popup allowing the user to accept or cancel the operation.

45. The method of claim 40, wherein the options available for the contextual menu include different tasks over the selected widget element, depending on the type of widget. Options include changing the data source and the frequency of display, and the restoration of default values.

46. The method of claim 40, wherein the options available for the contextual menu include different tasks over the selected application element of the panel of installed applications (FIG. 4), like changing the category, uninstalling applications and obtaining additional information.

47. The method of claim 46, wherein the Category option of the contextual menu allows the user to move the application to a different section or alternatively cancel the operation.

48. The method of claim 46, wherein the Uninstall option of the contextual menu uninstalls the focused application element (link). This operation is confirmed by means of a popup dialog allowing the user to accept or cancel the operation.

49. The method of claim 46, wherein the Information option of the contextual menu redirects the user to a view containing information of the application; on Android™ Operating System the Application Info view is launched.
